(19) United States
(12) Patent Application Publication
(10) Pub. No.: US 2025/0278358 A1
(43) Pub. Date: Sep. 4, 2025

(54) BUFFERING CLIENT FOR SYSTEM CONNECTION DETAILS

(71) Applicant: SAP SE, Walldorf (DE)

(72) Inventors: Christian SCHMITZ, Porto Alegre (BR); Peter SCHOENAU, Untergruppenbach (DE)

(21) Appl. No.: 18/756,219

(22) Filed: Jun. 27, 2024

Related U.S. Application Data
(60) Provisional application No. 63/560,189, filed on Mar. 1, 2024.

(51) Int. Cl. G06F 12/02

(52) U.S. Cl. CPC G06F 12/0246; G06F 2212/7203

(57) ABSTRACT

Systems and methods include reception of a first request from a first instance of a first connector service, the first request specifying a first connection identifier, determination that first connection details associated with the first connection identifier are stored in a local memory buffer, transmission of the first connection details from the local memory buffer to the first instance in response to the determination that the first connection details are stored in the volatile memory buffer, and reception of a notification indicating that the first connection details have changed. In response to the notification, the notification is stored in a persistent storage, the first connection details stored in the local memory buffer are invalidated, and an instruction is transmitted to the first instance of the first connector service to invalidate the first connection details stored at the first instance.

### CROSS-REFERENCE TO RELATED APPLICATIONS

The present application claims priority to and the benefit of U.S. Provisional Patent Application No. 63/560,189, filed Mar. 1, 2024, under 35 U.S.C. § 119(e). The contents of U.S. Provisional Patent Application No. 63/560,189 are incorporated herein for all purposes.

### BACKGROUND

Modern organizations generate, process and store vast amounts of data. This data may be stored in various data stores and accessed by various applications. Different data stores are differently suited for storing different types of data. Moreover, a given application may use different types of data associated with different requirements.

The particular data stores in which data of an application are stored may be selected based on many factors, including but not limited to a desired redundancy, a desired accessibility, a desired processing speed, and a desired security protocol. Due to these considerations, application data may be stored across multiple databases, file storages, file systems, and external data sources such as third-party vendors, cloud services, and cloud databases.

The diversity of data stores increases the complexity of data integration. For example, the more types of data stores which are used within an application landscape, the more difficult it is to seamlessly pull and push data and metadata from the data stores. Problems arise at least due to the difficulty in properly configuring the application to connect to and interact with the data stores. In addition, existing middleware for routing communication between an application and its data stores suffers from poor scalability and extensibility.

Connection to a data store typically requires corresponding user credentials and network details. This information may change from time-to-time and may also be subject to strict security protocols. For example, persistence of user credentials may be permitted only in secure data stores which conform to particular access and encryption standards. These freshness and data security issues pose further obstacles to seamless and efficient integration of data stores within an application landscape.

### BRIEF DESCRIPTION OF THE DRAWINGS

FIG. 1 illustrates a framework for connecting to data systems according to some embodiments.

FIG. 2 is a sequence diagram illustrating acquisition of connection details by a connector within a framework according to some embodiments.

FIG. 3 is an entity relationship diagram related to connector credentials change information according to some embodiments.

FIG. 4 illustrates hardware implementations of framework services according to some embodiments.

FIG. 5 is a sequence diagram illustrating invalidation of connection details in buffers of registry instances and connector instances according to some embodiments.

FIG. 6 illustrates invalidation of connection details in buffers of registry instances and connector instances according to some embodiments.

FIG. 7 illustrates a hardware implementation of a cluster-implemented framework according to some embodiments.

### DETAILED DESCRIPTION

Embodiments may provide scalable, resilient, observable, extensible, and high-performance connectivity with disparate data systems.

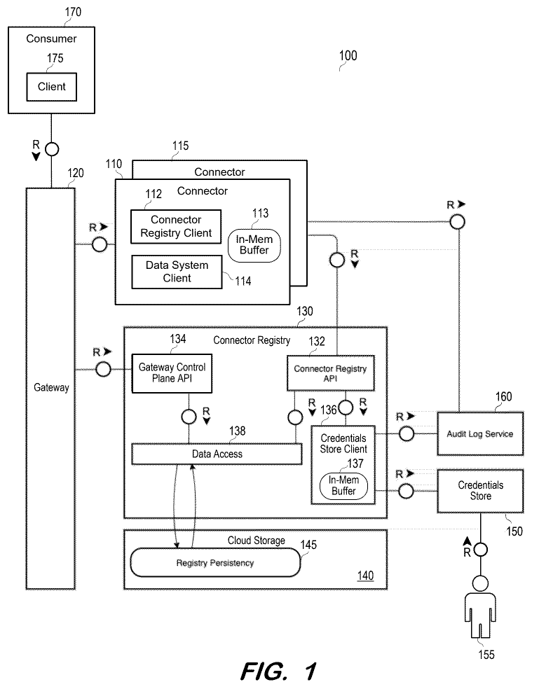

FIG. 1 illustrates landscape 100 according to some embodiments. Landscape 100 may comprise any number of hardware and software components which provide functionality to one or more users (not shown). The components may be implemented using any suitable combinations of computing hardware and/or software that are or become known. Such combinations may include on-premise servers, cloud-based servers, and/or elastically-allocated virtual machines. In some embodiments, two or more components are implemented by a single computing device.

Landscape 100 comprises connectors 110 and 115, which provide integration with data and metadata stored by data systems of different connection and endpoint types. Examples of connection types include but are not limited to ABAP, Google BigQuery, and S4/HANA Cloud, and examples of endpoint types include but are not limited to Web Socket RFC (WSRFC), REST, and Content Distribution Internetworking (CDI). Gateway 120 receives an incoming request for access to a data system of a particular connection type and endpoint type and routes the incoming request to a connector corresponding to the connection type, endpoint type and tenant. Connector registry 130 provides routing information to gateway 120 and connection details to deployed connectors 110 and 115. Connection details may include information needed to connect to a data system, such as hostname, port, username, password, certificates, etc. Connector registry 130 may also manage connector registration, cache connection details in in-memory buffer 137, and notify connectors 110, 115 of connection detail updates and connection invalidations.

Embodiments may implement any number of connectors, each of which is associated with one or more respective connection types, endpoint types and tenants. A connector implements logic for reading and writing data and metadata from and to a data system instance of the connection type and endpoint type with which the connector is associated. Each connector 110, 115 implements and exposes the same well-defined and parametrizable connector API which may be called by a consumer to interact with a data system of the connection type and endpoint type associated with the connector.

Consumer 170 may comprise a computing device which uses client component 175 to communicate with gateway 120 via the connector API. Client component 175 may encapsulate the communication and actions between consumer 170 and gateway 120. Client component 175 may be tasked with managing gRPC connections, checking the backend's and connectors' health status, security, resilience, and other aspects.

For example, via gateway 120, connector 110 may receive API calls from consumer 170 to read and write data, read and write metadata, and modify data definitions. Data system client 114 may convert the requests from a data model of connectors 110, 115 to a data model of a connection type and endpoint type with which connector 110 is associated and transmit the requests to a data system using connection details received from connector registry 130. Similarly, data system client 114 may receive responses from a data system and convert the responses from the data model of the data system to the data model of connectors 110, 115.

A connector may provide consumer 170 with information specifying its characteristics and capabilities. For example, consumer 170 may transmit a request to gateway 120 requesting such capabilities associated with a particular connector ID. Connectors 110, 115 may conform to a capability model which obliges a consumer to send commands to read or write data within the set of operations delimited by the connector's capabilities,

According to some embodiments, each connector 110, 115 is a separate microservice that exposes and implements the connector API. Each microservice (i.e., connector) may be provided by a plurality of pods executing connector instances in one or more nodes of a container orchestration system as is known in the art. Landscape 100 may be a cloud-native and decoupled architecture in which gateway 120 and connector registry 130 each also comprise separate microservices implemented by a respective one or more nodes. Consequently and advantageously, each of connectors 110, 115, gateway 120 and connector registry 130 may scale elastically (e.g., by adding/deleting pods and/or nodes) according to their respective workloads. All microservices described herein may communicate with one another and with other unshown microservices using lightweight network communication mechanisms such as a resource API via Hyper Text Transfer Protocol (HTTP) request-response messages, but embodiments are not limited thereto.

According to some embodiments, landscape 100 uses gRPC for communication among the components, Protocol Buffers as an interface description language for message, service, and API definitions, and a data wire format such as Apache Arrow. Connectors 110, 115, gateway 120 and registry 130 may execute on an application server that runs and operates applications on Kubernetes.

Connector registry 130 comprises connector registry API 132, gateway control plane API 134, and credentials store client 136. Connector registry API 132 may comprise a bi-directional gRPC API. During bootstrapping, connector registry client 112 of connector 110 invokes connector registry API 132 to register its information with connector registry 130. The information may include, for example, connector ID, connector version, configuration, connection type, endpoint type, and supported tenants.

Connector registry API 132 calls data access object 138 to persist the connector-specific information in registry persistency 145 of cloud storage 140. Registry persistency 145 may synchronize with the infrastructure layer of landscape 100 to also maintain a list of the available instances (e.g., running pods) for each registered connector.

Connector registry API 132 provides RPCs for connectors to retrieve connection details from credentials store client 136. Credentials store client 136 connects to credentials store 150 to obtain connection details such as hostname, port, credentials associated with a connection ID. Connection details may also include certificate-related information as will be described below.

Due to the sensitivity of connection details, credentials store 150 may comprise a secure persistent storage system. User 155 (e.g., a tenant administrator) accesses credentials store 150 to store connection details for data systems to which the user has access. For example, each data system (and the connection details thereof) may be associated with a connection ID within credentials store 150.

Credentials store client 136 includes local in-memory (i.e., volatile) buffer 137 to buffer connection details retrieved from credentials store 150. Such buffering may avoid unnecessary calls to credentials store 150 and provide resilience in case of communication issues with credentials store 150. Similarly, connector 110 also includes local volatile in-memory buffer 113 to buffer connection details received from connector registry 130 to avoid unnecessary calls to connector registry 130 and provide resilience in case of communication issues with connector registry 130. Storage of the connection details in an in-memory buffer provides increased security in comparison to storage of the connection details in a persistent store.

In one example, connector 110 receives a request from gateway 120 including a connection ID and determines that connection details for the connection ID are not stored in buffer 113 (or that the connection details therein are for some reason invalid). Connector registry client 112 then requests connection details of connector 110 from connector registry 130. In response, credentials store client 136 may determine that the requested details are not stored in buffer 137. Credentials store client 136 requests the connection details from credentials store 150, receives and caches the connection details in buffer 137, and returns the connection details to connector 110 via API 132. Connector 110 may then store the connection details in buffer 113 and use the connection details to forward a request to its associated data system.

Connector 110 may use the connection details stored in buffer 113 to respond to subsequent requests from gateway 120. Similarly, credentials store client 136 may use the connection details stored in buffer 137 to respond to subsequent requests for connection details from connectors of the same connection type and endpoint type as connector 110. If credentials store client 136 uses the connection details stored in buffer 137 to respond to a subsequent request for connection details, credentials store client 136 may forward an audit record to audit log service 160 to fulfill security and auditing requirements.

As will be described below, embodiments provide systems to ensure consistency of buffered connection details among the various simultaneously-executing instances of connector registry 130 and connectors 110, 115. Ensuring such consistency ensuring that connection details which are stored in instances of buffers 113 and 137 are not used by a connector if the connection details have been previously invalidated at credentials store 150.

Gateway control plane API 134 provides routing information to gateway 120. Gateway 120 caches the routing information and uses the routing information to route incoming requests to appropriate connectors. Gateway 120 routes incoming requests to connectors based on connection information (e.g., connection type, endpoint type, tenant) specified by the requests. Routing may be based on other types of information specified in a request. Gateway 120 may comprise an L7 load balancer that supports HTTP/2 and connections multiplexing, which allows the reuse of the same TCP socket for multiple HTTP connections.

Gateway 120 can survive outages of gateway control plane API 134 using cached routing information, at least until the routing information stored in registry persistency 145 changes. Routing information stored in registry persistency 145 may change due to asynchronous registration or de-registration of connectors. To keep the routing information of gateway 120 up-to-date, gateway 120 may maintain a live gRPC stream to gateway control plane API 134. Accordingly, gateway control plane API 134 may regularly pull routing information from registry persistency 145 of cloud storage 140 via data access object 138 and determine whether any of the routing information has changed. If so, all current routing information stored in registry persistency 145 (or, in some embodiments, only the changed routing information) is transmitted to gateway 120. According to some embodiments, prior to transmission of the routing information stored gateway control plane API 134 translates routing information entities corresponding to the connector data model into entities (e.g., configurations, actions and matchers) of the data model of gateway 120.

As mentioned above, gateway 120 may be implemented using multiple instances. When a new instance is deployed, the instance calls gateway control plane API 134 to create a gRPC bi-directional stream and thereafter calls the gateway control plane API 134 to retrieve a routing configuration including all current routing information from registry persistency 145.

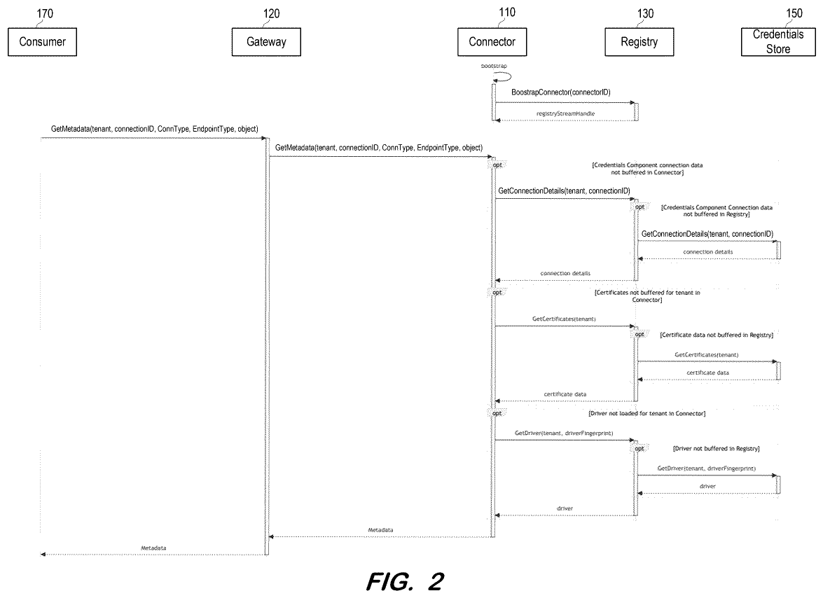

FIG. 2 is a sequence diagram illustrating acquisition of connection details by a connector within a framework according to some embodiments. Process 200 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture.

FIG. 2 will be described with respect to the components of landscape 100, but embodiments are not limited thereto. During bootstrap of connector 110, connector registry client 112 of connector 110 requests a connection with connector registry 130 via connector registry API 132 to open a long-lived gRPC channel associated with a connector ID of connector 110. Registry 130 responds with a stream handle of the channel, which acts as a corridor for actions to be executed during bootstrap and across the life of connector 110 to allow registration of connector 110, transfer of connection details from registry 130 to connector 110, and determination of the status (e.g., running, terminated) of connector 110.

During registration, connector 110 uses the corridor to call connector registry 130 and provides its connector information. The connector information may include a connector ID, the connection type and endpoint type to which connector 110 provides connectivity, the associated tenant (if not multi-tenant), a connector version, the endpoint of the registering connector instance, and any remaining configuration information needed for operation of connector 110 and routing of incoming requests. For example, the connector information may specify that connector 110 requires one or more drivers to communicate with its data system. In this case, the connector information may include fingerprints of the one or more drivers.

Connector registry 130 may translate the received connector information into native entities of a connector registry persistency data model. The translated connector information is persisted in cloud storage 140. Next, connector registry 130 reads all the persisted connector information from cloud storage 140 and converts the entities of the connector information to a data model of gateway 120. Connector registry 130 sends the converted connector information to gateway 120 to update its internal routing configuration. Accordingly, gateway 120 includes a routing configuration which reflects the current state of the connector information stored in persistency 145 of cloud storage 140.

Returning to FIG. 2, consumer 170 transmits a request to get metadata of a data system to gateway 120. Consumer 170 may initially send a request to create a channel to gateway 120 via client component 175, and the request to get metadata is then sent over the created channel. Although the example of FIG. 2 illustrates a request to get metadata, the request may comprise a request to read data/metadata, a request to write data, or a Data Description Language request according to some embodiments.

The request sent from consumer 170 includes, e.g., a tenant, a connection ID. a connection type, an endpoint type, and an object identifier. The connection ID is intended to correspond to a connection ID for which connection details were previously stored by the tenant in credentials store 150. Accordingly, the request need not specify any connection details for connecting to the target data system.

Based on the received connection information and its stored routing information, gateway 120 routes the request to corresponding connector 110. After receiving the request, connector 110 determines whether connection details corresponding to the connection ID of the request are stored in in-memory buffer 113. If not, connector 110 calls registry 130 (e.g., using a connector registry client as described above) to request the connection details.

Connector registry 130 determines whether connection details corresponding to the connection ID and tenant are stored in in-memory buffer 137. If so, registry 130 sends the connection details to connector 110 for storage in buffer 113. If the connection details are not in in-memory buffer 137, credentials store client 136 of connector registry 130 calls credentials store 150 to request the connection details, stores the connection details in buffer 137, and sends the connection details back to connector 110 for storage in buffer 113.

The connection details received from registry 130 (or already stored in buffer 113) may include a certificate fingerprint indicating that a certificate is required to access the data system. If so, and if the certificate is not already stored in in-memory buffer 113, connector 110 requests the certificate corresponding to the certificate fingerprint and tenant from the registry from registry 130. In response, connector registry 130 determines whether the requested certificate is stored in in-memory buffer 137. If so, registry 130 returns the certificate to connector 110. If not, connector registry 130 calls credentials store 150 to request the certificate, stores the certificate in buffer 137, and returns the certificate to connector 110. In either case, the returned certificate may be stored in buffer 113.

As previously mentioned, connectors may require drivers to operate. The drivers might not be bundled into the connectors due to licensing or other restrictions. Users can therefore upload their licensed drivers for the tenant to credentials component 150. When connector 110, for example, receives a request, it looks for the tenant information and checks whether its driver is stored in in-memory buffer 113. If not, connector 110 contacts the registry 130 for the driver for that tenant.

Registry 130 determines whether the driver is stored in in-memory buffer 137 and, if so, returns the driver to connector 110. If the driver is not stored in in-memory buffer 137, registry 130 calls credentials store 150 to determine whether the driver is stored in credentials store 150. If so, registry 130 calls credentials store 150 to retrieve the driver and returns the driver to connector 110. Connector 110 may store the returned driver in buffer 113.

Connector 110 then uses the connection details, certificate (if needed) and driver (if needed) to transmit the request for metadata to the target data system (not shown). Connector 110 receives the result and returns the result to consumer 170 via gateway 120. If the connection details, certificate, or driver are not available in buffers 113, 137 or credentials store 150, an error is returned to connector 110 and may be forwarded to consumer 170.

In some embodiments, buffering the driver, certificate, and connection details in connector registry 130 advantageously provides faster response times and resilience against an outage of credentials store 150. Since drivers are large (e.g., tens of MB), tenant-specific, and/or subject to licensing, some embodiments do not buffer drivers and instead load drivers from credentials store 150 into corresponding connectors at startup.

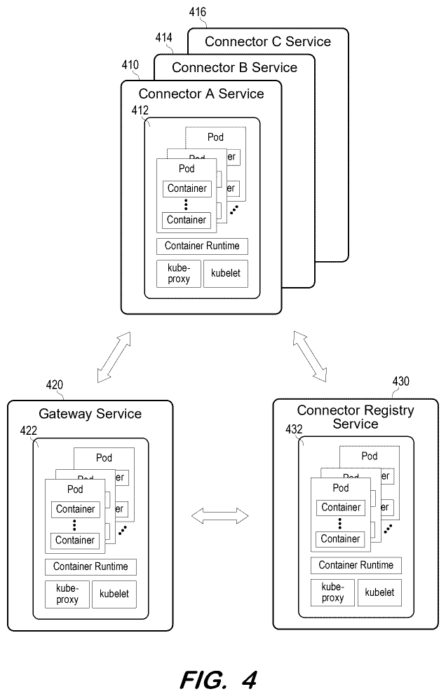

FIG. 4 illustrates implementations of connectors 410, 414 and 416 gateway 420 and connector registry 430 according to some embodiments. Each of services 410, 414, 416, 420 and 430 may be implemented by a plurality of pods of a container orchestration platform such as but not limited to Kubernetes. As such, each service may include a node executing several pods, in which each pod executes a separate instance of the service. Each node 412, 422 and 432 is a virtual or physical machine including kubelet for node and container management, kube-proxy for a network proxy, and a container runtime (e.g., Docker) to run container.

Although FIG. 4 illustrates one node 412, 422 and 432 per service, any service may include any number of nodes, each executing its own set of one or more pods. A master node (not shown) of each service may adjust the number of pods, the number of nodes and/or the computing resources of each node as desired. The adjustment may be based on expected workload or any other factors. For example, if an expected workload is greater than a first threshold, one or more additional pods are created. If the expected workload is less than a second threshold, one or more of pods are terminated.

Accordingly, each of connector services 410, 414, 416 may be implemented by several connector instances and connector registry service 430 may be implemented by several connector registry instances, in which all instances execute independently and in parallel. If a connector registry client of a connector instance registers its connector information using a connector registry API of a connector registry instance, all other connector registry instances will initially be unaware of the registration. Accordingly, to establish a consistent state of connector information throughout the landscape, each running connector registry instance may periodically read the connector information from the shared cloud storage and push the connector information to the gateway instance(s) to which it is connected.

As described above, some embodiments advantageously buffer connection details, certificates, and drivers in a connector registry and/or in connectors. If connection details, certificates, and/or drivers are changed or deleted in credentials store 150, all connector registry instances and each connector instance which buffer the changed/deleted data should be notified.

This notification is accomplished in some embodiments by providing a callback for push notifications in credentials store 150. Using this callback, one connector registry instance receives notifications of changes/deletions from credentials store 150, and the notifications are propagated to all other connector registry instances. Each connector registry instance then sends the notifications to the connector instances which established a bidirectional connection with the connector registry instance during bootstrapping as described above.

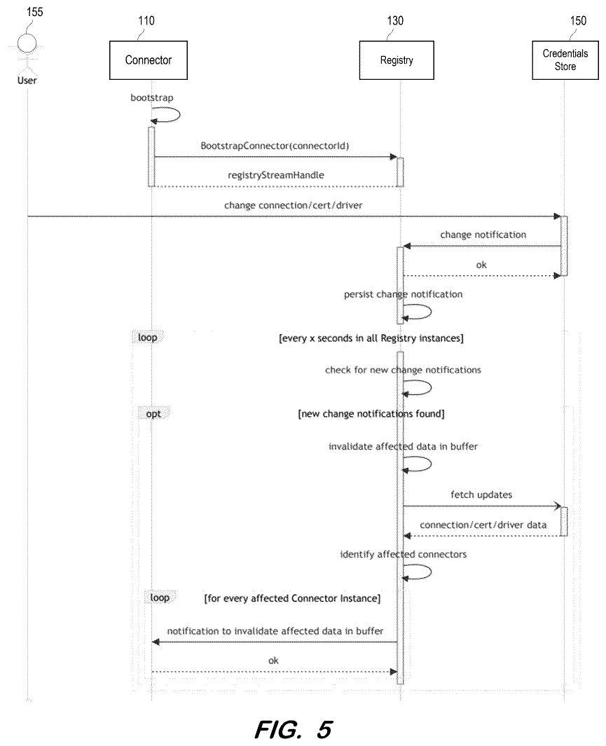

FIG. 5 is a sequence diagram illustrating invalidation of connection details in buffers of registry instances and connector instances according to some embodiments. During bootstrap of connector 110, a long-lived gRPC channel associated with a connector ID of connector 110 is opened with registry 130. The channel is used to register information of connector 110 and to transfer connection details from registry 130 for use and/or buffering therein.

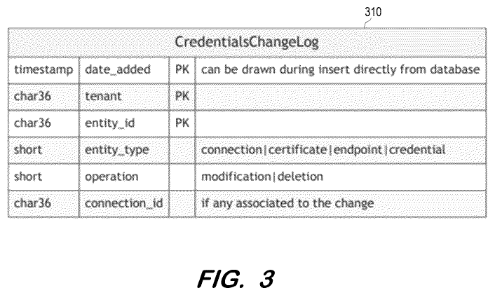

During operation, user 155 may communicate with credentials store 150 to change connection details, a driver and/or a certificate associated with a connection ID. Using the above-described callback, credentials store 150 transmits a notification to registry 130 notifying registry 130 of the change. Registry 130 acknowledges the notification and persists the notification to cloud storage 140. The notification may identify invalidated connection details, drivers, and certificates per tenant. The notification may be timestamped to facilitate purging of stale change information from storage 140. FIG. 3 illustrates attributes of a CredentialsChangeLog entity 310 which may be used as a notification and persisted in cloud storage 140 as described above according to some embodiments.

Each connector registry instance may be programmed in some embodiments to periodically (e.g., every 10 s) check the persistence for change notifications which was stored since a last check. Assuming that a registry instance identifies a change notification which was stored since its last check, the connector registry instance and invalidates (e.g., deletes from the buffer or marks as invalid) the identified changed connection details, certificates, and/or drivers.

Next, the connector registry instance fetches the changed connection details, certificates, and/or drivers from the persistence, certificates or drivers stored in its in-memory buffer have been changed. The connector registry instance identifies connector instances to which it is connected, and which are associated with the connection ID corresponding to the changes. The connector registry instance then instructs these connector instances to invalidate the changed data (i.e., connection details, certificate, and/or driver) if stored in their buffers. In some embodiments, the connector registry instance pushes the new data to corresponding connector instances with instructions to update their buffers with the new data.

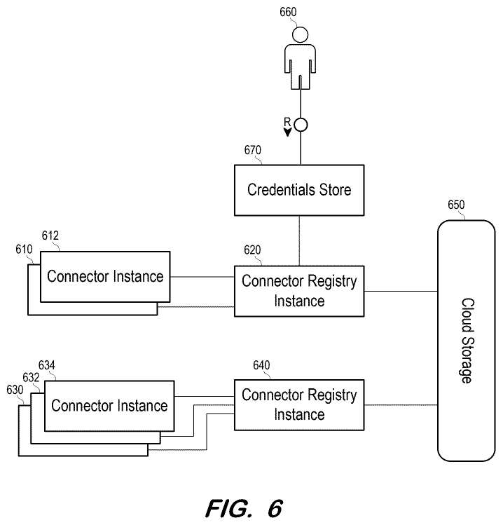

FIG. 6 illustrates component instances for describing an example of the sequence diagram of FIG. 5. User 660 changes connection details, a driver and/or a certificate stored in credentials store 670 in association with a connection ID. Credentials store client 150 transmits a notification of the change to connector registry instance 620. Connector registry instance 620 persists the change notification to cloud storage 650.

Soon thereafter, connector registry instance 620 checks cloud storage 650 for change notifications which were stored since a last check. Connector registry instance 620 determines that a change notification was stored since its last check and invalidates connection details, certificates, and/or drivers identified in the change notification and stored in its in-memory buffer.

Connector registry instance 620 then fetches the changed information from cloud storage 650, identifies connector instances 610, 612 to which it is connected via respective gRPC long-lived channels, and determines whether any of connector instances 610, 612 are associated with the connection ID and/or tenant corresponding to the changes. Connector registry instance 620 instructs its connector instances associated with the connection ID and/or tenant to invalidate the changed data (i.e., connection details, certificate, and/or driver) if the prior version is stored in their buffers. In some embodiments, the connector registry instance pushes the new data to corresponding connector instances with instructions to update their buffers with the new data.

Similarly, and independently from connector registry instance 620, connector registry instance 640 checks cloud storage 650 for change notifications which were stored since its last check and fetches the recently-stored change notifications from cloud storage 650. Connector registry instance 640 invalidates any changed connection details, certificates, or drivers from its in-memory buffer, fetches the changes, and determines whether any of connector instances 630, 632, 634 with which it is connected are associated with the connection ID and/or tenant corresponding to the changes. Connector registry instance 640 instructs such ones of connector instances 630, 632, 634 to invalidate the changed data if the prior version of the data is stored in their buffers. In some embodiments, each connector registry instance updates its in-memory buffer with newly-changed data and/or pushes the newly-changed data to its connected connector instances with instructions to update their buffers with the data.

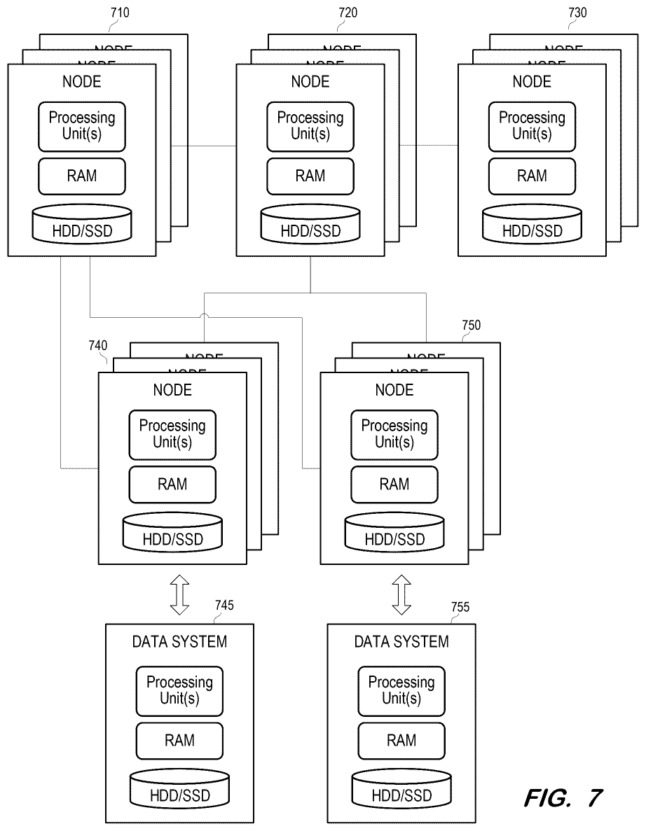

FIG. 7 illustrates a cloud-based deployment according to some embodiments. The illustrated components may comprise cloud-based resources residing in one or more public or private clouds providing self-service and immediate provisioning, autoscaling, security, compliance and identity management features.

Each illustrated node may comprise a physical or virtual machine of a container orchestration platform cluster. Nodes 710 may execute instances of a gateway while nodes 720 may execute instances of a connector registry. Nodes 730 may comprise a database service for storing connector-specific information. Nodes 740 may execute instances of a first connector and nodes 750 may execute instances of a second connector. The instances of the first connector may communicate with data system 745 and the instances of the second connector may communicate with data system 755.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing program code;
a volatile memory buffer;
one or more processing units to execute the program code to cause the system to execute a first instance of a first connector registry service to:
receive a first request from a first instance of a first connector service, the first request specifying a first connection identifier;
determine that first connection details associated with the first connection identifier are stored in the volatile memory buffer;
in response to the determination that the first connection details are stored in the volatile memory buffer, transmit the first connection details from the volatile memory buffer to the first instance of the first connector service;
receive a notification indicating that the first connection details have changed;
and in response to the notification indicating that the first connection details have changed:
store the notification in a persistent storage; and
invalidate the first connection details stored in the volatile memory buffer.

2. The system of claim 1, the one or more processing units to execute the program code to cause the system to execute the first instance of the first connector registry service to:
transmit an instruction to the first instance of the first connector service to invalidate the first connection details stored at the first instance of the first connector service.

3. The system of claim 1, the one or more processing units to execute the program code to cause the system to execute the first instance of the first connector registry service to:
receive a second request from a first instance of a second connector service, the second request specifying a second connection identifier;
determine that second connection details associated with the second connection identifier are not stored in the volatile memory buffer; and
in response to the determination that the second connection details are not stored in the volatile memory buffer:
request the second connection details from a secure data store;
receive the second connection details from the secure data store;
store the second connection details in the volatile memory buffer; and
transmit the second connection details to the first instance of the second connector service.

4. The system of claim 3, wherein the notification is received from the secure data store.

5. The system of claim 3, the one or more processing units to execute the program code to cause the system to execute the first instance of the first connector registry service to:
receive a second notification indicating that the second connection details have changed; and
in response to the second notification indicating that the second connection details have changed:
store the second notification in the persistent storage; and
transmit a second instruction to the first instance of the second connector service to invalidate the second connection details stored at the first instance of the second connector service.

6. The system of claim 5, wherein the notification and the second notification are received from the secure data store.

7. The system of claim 1, the one or more processing units to execute the program code to cause the system to execute a second instance of the first connector registry service to:
determine the first connection details stored in the persistent storage; and
in response to determination of the first connection details, transmit an instruction to a second instance of the first connector service to invalidate the first connection details stored at the second instance of the first connector service.

8. The system of claim 7, the one or more processing units to execute the program code to cause the system to execute a second instance of the first connector registry service to:
in response to determination of the notification, determine that a first instance of a second connector service with which the first connector registry service is in communication is not associated with the first connection details; and
in response to the determination that the first instance of the second connector service is not associated with the first connection details, do not transmit an instruction to the first instance of the second connector service to invalidate the first connection details.

9. A method comprising:
receiving, at a first instance of a first connector registry service, a first request from a first instance of a first connector service, the first request specifying a first connection identifier;
determining, at the first instance of the first connector registry service, that first connection details associated with the first connection identifier are stored in a local volatile memory buffer;
in response to determining that the first connection details are stored in the local volatile memory buffer, transmitting the first connection details from the first instance of the first connector registry service to the first instance of the first connector service;
receiving, at the first instance of the first connector registry service, a notification indicating that the first connection details have changed; and
in response to the notification indicating that the first connection details have changed:
storing the notification in a persistent storage; and
invalidating the first connection details stored in the local volatile memory buffer.

10. The method of claim 9, further comprising:
transmitting, from the first instance of the first connector registry service, an instruction to the first instance of the first connector service to invalidate the first connection details stored at the first instance of the first connector service.

11. The method of claim 9, further comprising:
receiving, at the first instance of the first connector registry service, a second request from a first instance of a second connector service, the second request specifying a second connection identifier;
determining, at the first instance of the first connector registry service, that second connection details associated with the second connection identifier are not stored in the local volatile memory buffer; and
in response to determining that the second connection details are not stored in the local volatile memory buffer:
requesting, by the first instance of the first connector registry service, the second connection details from a secure data store;
receiving, at the first instance of the first connector registry service, the second connection details from the secure data store;
storing, by the first instance of the first connector registry service, the second connection details in the local volatile memory buffer; and
transmitting, from the first instance of the first connector registry service, the second connection details to the first instance of the second connector service.

12. The method of claim 11, wherein the notification is received from the secure data store.

13. The method of claim 11, further comprising:
receiving at the first instance of the first connector registry service, a second notification indicating that the second connection details have changed; and
in response to the second notification indicating that the second connection details have changed:
storing, by the first instance of the first connector registry service, the second notification in the persistent storage; and
transmitting, from the first instance of the first connector registry service, a second instruction to the first instance of the second connector service to invalidate the second connection details stored at the first instance of the second connector service.

14. The method of claim 13, wherein the notification and the second notification are received from the secure data store.

15. The method of claim 9, further comprising:
determining, at a second instance of the first connector registry service, the notification stored in the persistent storage; and
in response to determination of the notification, transmitting, from the second instance of the first connector registry service, an instruction to a second instance of the first connector service to invalidate the first connection details stored at the second instance of the first connector service.

16. The method of claim 15, further comprising:
in response to determining the notification, determining, at the second instance of the first connector registry service, that a first instance of a second connector service with which the first connector registry service is in communication is not associated with the first connection details; and
in response to determining that the first instance of the second connector service is not associated with the first connection details, not transmitting, from the second instance of the first connector registry service, an instruction to the first instance of the second connector service to invalidate the first connection details.

17. One or more non-transitory computer-readable media storing program code that, when executed by a computing system, cause the computing system to perform operations comprising:
receiving a first request from a first instance of a first connector service, the first request specifying a first connection identifier;
determining that first connection details associated with the first connection identifier are stored in a local memory buffer;
in response to the determination that the first connection details are stored in the volatile memory buffer, transmitting the first connection details from the local memory buffer to the first instance of the first connector service;
receiving a notification indicating that the first connection details have changed; and
in response to the notification indicating that the first connection details have changed:
storing the notification in a persistent storage;
invalidating the first connection details stored in the local memory buffer; and
transmitting an instruction to the first instance of the first connector service to invalidate the first connection details stored at the first instance of the first connector service.

18. The one or more non-transitory computer-readable media of claim 17, the program code, when executed by a computing system, to cause the computing system to perform operations comprising:
receiving a second request from a first instance of a second connector service, the second request specifying a second connection identifier;
determining that second connection details associated with the second connection identifier are not stored in the local memory buffer; and
in response to determining that the second connection details are not stored in the local memory buffer:
requesting the second connection details from a secure data store;
receiving the second connection details from the secure data store;
storing the second connection details in the local memory buffer; and
transmitting the second connection details to the first instance of the second connector service.

19. The one or more non-transitory computer-readable media of claim 18, the program code, when executed by a computing system, to cause the computing system to perform operations comprising:
receiving a second notification indicating that the second connection details have changed; and
in response to the second notification indicating that the second connection details have changed:
storing the second notification in the persistent storage; and
transmitting a second instruction to the first instance of the second connector service to invalidate the second connection details stored at the first instance of the second connector service.

20. The one or more non-transitory computer-readable media of claim 19, the program code, when executed by a computing system, to cause the computing system to perform operations comprising:
determining the notification stored in the persistent storage; and
in response to determining the notification, transmit an instruction to a second instance of the first connector service to invalidate the first connection details stored at the second instance of the first connector service.
